(19) United States
(12) Patent Application Publication
(10) Pub. No.: US 2006/0156291 A1
(43) Pub. Date: Jul. 13, 2006

(54) System and method for managing processor execution in a multiprocessor system

(75) Inventors: Samer El-Haj Mahmoud, Austin, TX (US); Vijay Nijhawan, Round Rock, TX (US)

Correspondence Address: Roger Fulghum;Baker Botts L.L.P., One Shell Plaza, 910 Louisiana Street, Houston, TX, 77002-4995, US

(73) Assignee: DELL PRODUCTS L.P.

(21) Appl. No.: 11/034,381

(22) Filed: Jan. 12, 2005

(51) Int. Cl. G06F 9/44

(52) U.S. Cl. 717/129

(57) ABSTRACT

A multiprocessor information handling system and method for operation is disclosed in which each of the processors of the system executes a software program according to a controlled execution scheme. A bootstrap processor sets a grouping of processor-specific flags to identify whether each respective processor is enabled to execute the software program. If the processor is enabled to execute the software program, the processor executes the software program and resets the processor-specific flag so that the software program will not be executed a second time by the processor or a logical processor of the processor.

### TECHNICAL FIELD

The present disclosure relates generally to information handling systems, and, more particularly to a system and method for managing processor execution in a multiprocessor system.

### BACKGROUND

As the value and use of information continues to increase, individuals and businesses seek additional ways to process and store information. One option available to these users is an information handling system. An information handling system generally processes, compiles, stores, and/or communicates information or data for business, personal, or other purposes thereby allowing users to take advantage of the value of the information. Because technology and information handling needs and requirements vary between different users or applications, information handling systems may vary with respect to the type of information handled; the methods for handling the information; the methods for processing, storing or communicating the information; the amount of information processed, stored, or communicated; and the speed and efficiency with which the information is processed, stored, or communicated. The variations in information handling systems allow for information handling systems to be general or configured for a specific user or specific use such as financial transaction processing, airline reservations, enterprise data storage, or global communications. In addition, information handling systems may include or comprise a variety of hardware and software components that may be configured to process, store, and communicate information and may include one or more computer systerns, data storage systems, and networking systems.

Information handling systems, including computer systems, may include multiple microprocessors, memory, and various input and output devices. The components of a computer system are communicatively coupled together using one or more interconnected buses. As an example, the architecture of a computer system may include a processor that is coupled to a processor bus or host bus. In the case of multiprocessor computer systems, two or more processors may be coupled to the processor bus. A memory controller bridge may be coupled between the processor bus and system memory. In addition, a PCI bridge may be coupled between the processor bus and the PCI bus of the computer system. In some computer systems, the memory controller bridge and the PCI bridge are incorporated into a single device, which is sometimes referred to as the north bridge of the computer system. An expansion bridge, sometimes referred to as a south bridge, couples the PCI bus to an expansion bus, such as the ISA bus. The south bridge also serves as a connection point for USB devices and an IDE bus. The south bridge may also include an interrupt controller.

A set of processors in a multiprocessor computer system typically include one processor that is identified as the bootstrap processor. The bootstrap processor executes the boot code of the computer system, including the power-on self-test (POST) code. The other processors of the computer system are referred to as application processors. Each processor may be logically subdivided into multiple logical processors. Each of the logical processors may execute in parallel different threads of one or more multi-threaded software applications. The logical processors may share some hardware resources of the processor. The logical processors of a processor may also share external resources, including the L3 cache of the computer system. When the computer system is initiated, each logical processor of each processor of the computer system may attempt to initialize or reset some resources that are common to all processors or common to all logical processors of the computer system. This circumstance will often result in a race condition in which each logical processor of the computer system attempts to access a semaphore and execute a task with respect to the common resource. Often, the resetting of each common resource by each processor or logical processor results in unnecessary processor contention and the waste of processor resources.

### SUMMARY

In accordance with the present disclosure, a multiprocessor information handling system and method for operation is disclosed in which each of the processors of the system executes a software program according to a controlled execution scheme. A bootstrap processor determines if a controlled execution mode is in effect and sets a bitmapped set of flags. Each processor checks the flags to determine if the processor must execute the software program in a controlled execution. If the processor must execute the software program in a controlled execution mode, each processor determines from a processor-specific flag in the set of flags if the processor is individually enabled to execute the software program. If the processor is enabled to execute the software program, the processor executes the software program and resets the processor-specific flag so that the software program will not be executed a second time by the processor or a logical processor of the processor.

The system and method disclosed herein is technically advantageous because it prevents contention by the processors for the execution of a software program. When the controlled execution mode is enabled, each processor of the information handling system cannot execute a designated software program until the processor gains control of a semaphore and unless the processor is individually enabled through a bitmapped flag to execute the software program. In this manner, each processor and the logical processor of each processor is prevented from repeatedly attempting to execute a designated software program. As a result, a software program that need only be executed once with respect to each processor of the computer system is not executed multiple times by each logical processor of the computer system.

Another technical advantage of the system and method disclosed herein is also advantageous in that it permits a bootstrap processor to govern the execution of some startup programs by the application processors of the computer system. Through a set of bitmapped flags, the bootstrap processor may enable certain processors to execute the startup program and may disable other processors from executing the startup program. The bootstrap program has control over those application processors of the computer system that will execute and will not execute a startup program. Other technical advantages will be apparent to those of ordinary skill in the art in view of the following specification, claims, and drawings.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is a diagram of the architecture of a computer system;

FIG. 2A is a diagram of a bitmapped flag;

FIG. 2B is a diagram of an extended bitmapped flag;

FIG. 2C is a diagram of a populated extended bitmapped flag;

FIG. 3 is a flow diagram of a method for setting flags transferring control over execution of a software task to the processors of the computer system; and

FIG. 4 is a flow diagram of a method for managing processor execution at each of the processors of the computer system.

### DETAILED DESCRIPTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communication with external devices as well as various input and output (I/O) devices, such as a keyboard, a mouse, and a video display. The information handling system may also include one or more buses operable to transmit communications between the various hardware components.

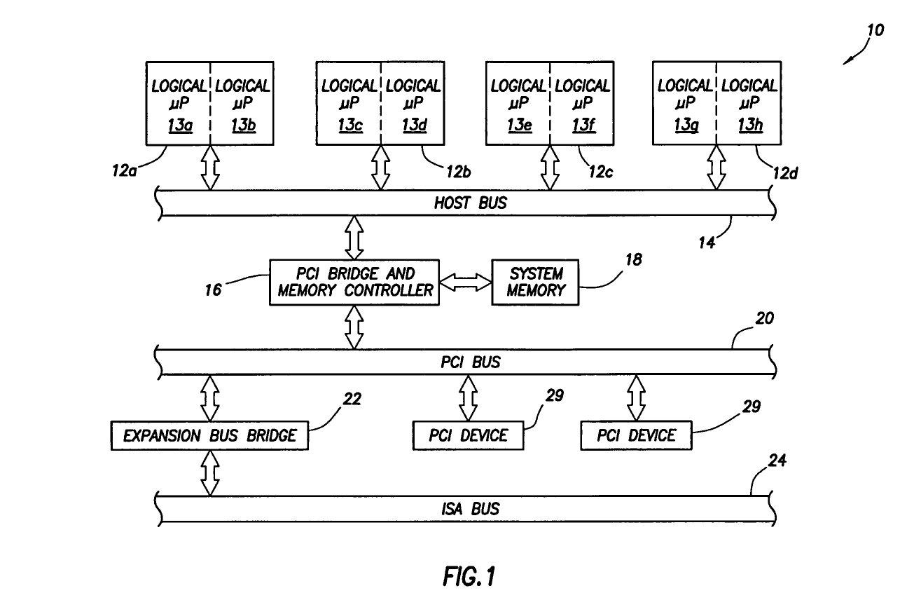

FIG. 1 is a diagram of the architecture of a computer system, which is indicated generally at 10. Computer system 10 is a multiple processor system and includes four processors, identified as processor 12a, processor 12b, processor 12c, and processor 12d. Each of the processors is coupled to a processor or host bus 14. Coupled to processor bus 14 is a PCI bridge and memory controller 16, which is sometimes referred to as a north bridge. System memory 18 is coupled to north bridge 16. North bridge 16 serves as a communications bridge between the host bus 14 and PCI bus 20. The computer system could have numerous host buses in the computer system, all of which would be coupled to the north bridge of the computer system. In the computer architecture of FIG. 1, PCI devices 29 are coupled to PCI bus 20. In the computer system 10 of FIG. 1, an expansion bus bridge 22 couples PCI bus 20 to an ISA bus 24. As just one alternative to the computer architecture shown in FIG. 1, expansion bus 22 could be coupled to a Super I/O device (not shown). Expansion bus bridge 22 is sometimes referred to as a south bridge. Each processor 12 may include multiple logical processors, which are indicated at 13. In the example of FIG. 1, each processor 12 includes two logical processors. Logical processors 13a and 13b are included in processor 12a. Logical processors 13c and 13d are included in processor 12b. Logical processors 13e and 13f are included in processor 12c, and logical processors 13g and 13h are included in processor 12d.

One of the processors 12 is the bootstrap processor and will execute the boot code of the computer system, including the power-on self-test code. The remaining processors are application processors. In the present disclosure, the processors will be referred to as Processor No. 1 (processor 12a of FIG. 1), Processor No. 2 (processor 12b), Processor No. 3 (processor 12c), and Processor No. 4 (processor 12d). For the sake of this disclosure, it will be assumed that Processor No. 1 (processor 12a) is the bootstrap processor. Each of the processors 12 may access common, nonvolatile memory in the computer system. This nonvolatile memory may comprise a register on the host bus of the computer system, such as register 24. Each of the processors may also access nonvolatile memory registers on PCI bridge and memory controller 16. In addition, each processor includes nonvolatile memory registers.

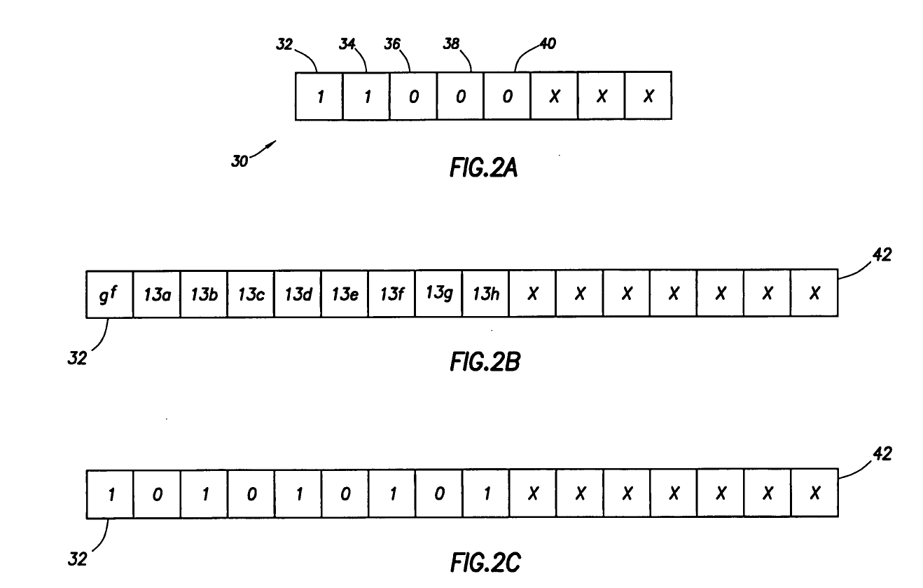

Shown in FIG. 2A is a bitmapped flag, which is indicated generally at 30. The bitmap flag 30 of FIG. 2A includes eight bits. The most significant bit 32 is associated with a global execution control signal. When bit 32 is set to a logical 1 , the computer system is in a global execution control mode, and the remaining bits of the bitmap flag are consulted for the execution control method. If bit 32 is set to a logical 0 , the execution control method is not enabled. In the example of FIG. 2A, the bit is set to a logical 1 , which indicates that the computer system is in a global execution control mode. Each of the remaining bits of the bitmap flag is associated with one of the processors of the computer system. Bit 34 is associated with processor 12a, which is the bootstrap processor. Bit 36 is associated with processor 12b. Bit 38 is associated with processor 12c, and bit 40 is associated with processor 12d. With respect to each of the bits 34-40, if the bit is set to a logical 1 , the processor associated with the bit does not attempt to execute a preidentified set of execution code. If the bit is set to a logical 0 , the processor associated with the bit, or a logical processor of the processor associated with the bit attempts to execute a preidentified set of execution codes. In the example of FIG. 2A, bit 34 , which is associated with bootstrap processor 12a, indicates that bootstrap processor 12a will not attempt to execute the set of software commands. Bits 36-40 are set to a logical 0 , indicating that each respective processor or a logical processor associated with the respective processor will attempt to execute the identified set of software commands.

Shown in FIG. 2B is a second example of a bitmapped flag. The extended bitmap flag 42 of FIG. 2B differs from the bitmap flag of FIG. 2A in that bitmap flag of FIG. 2B includes a bit associated with each of the logical processors of the computer system. Extended bitmap flag 42 includes a global execution control signal bit 32 (gf) as its most significant bit. The remaining logical processors bits are each uniquely associated with one of the logical processors of the computer system, as indicated by the notation of the reference numeral of associated logical processor in each respective bit location. If the global execution control bit 32 is set to a logical 1 , indicating that the computer system is in a global execution control mode, the setting of logical processor bits determines whether each respective logical processor will attempt to execute a preidentified set of execution codes. An example of extended bitmap flag 42 is shown in FIG. 2C. In this example, the bits of the bitmap flag are set so that only the first or primary logical processor will attempt to execute the set of software commands. The bit settings in the bitmap flag of FIG. 2C will result in logical processors 13a, 13c , 13e, and 13g attempting to execute the set of software commands.

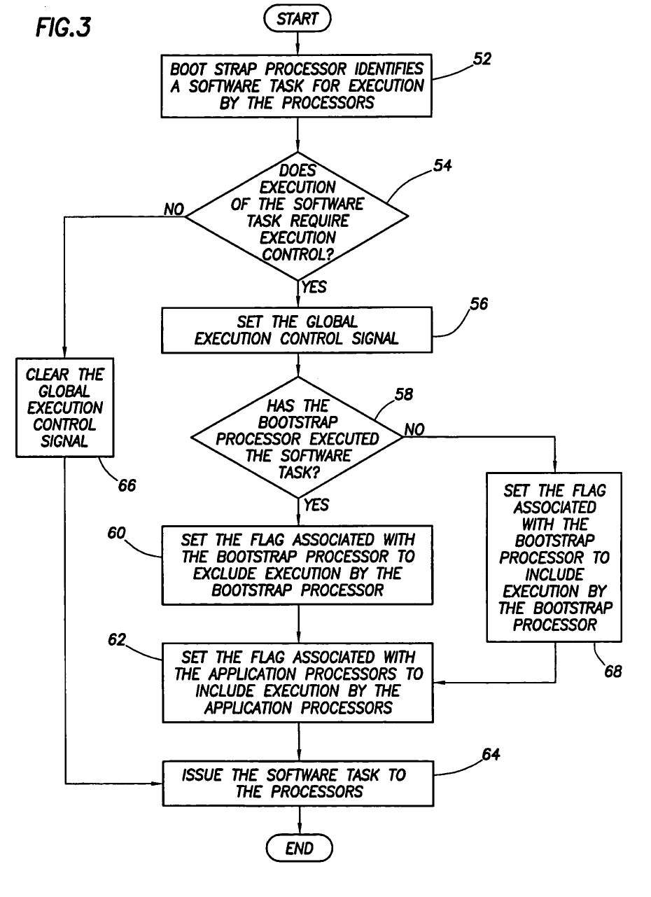

Shown in FIG. 3 is a flow diagram of a series of method steps for setting the bits of the bitmap flag and transferring control over execution of the software-task to the processors of the computer system. The method steps of FIG. 3 are performed with reference to the bootstrap processor. The software task may be a software task that is executed once with respect to each processor at the initiation of the computer system. In addition, the software task may be a task that need not be executed by each logical processor of the computer system. An example of this type of task could be the initialization of the L3 cache, or other processor components or internal registers, with respect to each processor of the computer system. Following the start of the flow diagram, the bootstrap processor at step 52 identifies a software task that is to be executed by each of the processors of the computer system. At step 54, the bootstrap processor determines if the software task requires execution control. If the software task does not require execution control, the global execution control signal 32 of the bitmap flag 30 is cleared and the software task is issued to the processors at step 64. Execution control need not be enabled if, for example, the software task will not result in contention among the processors of the computer system.

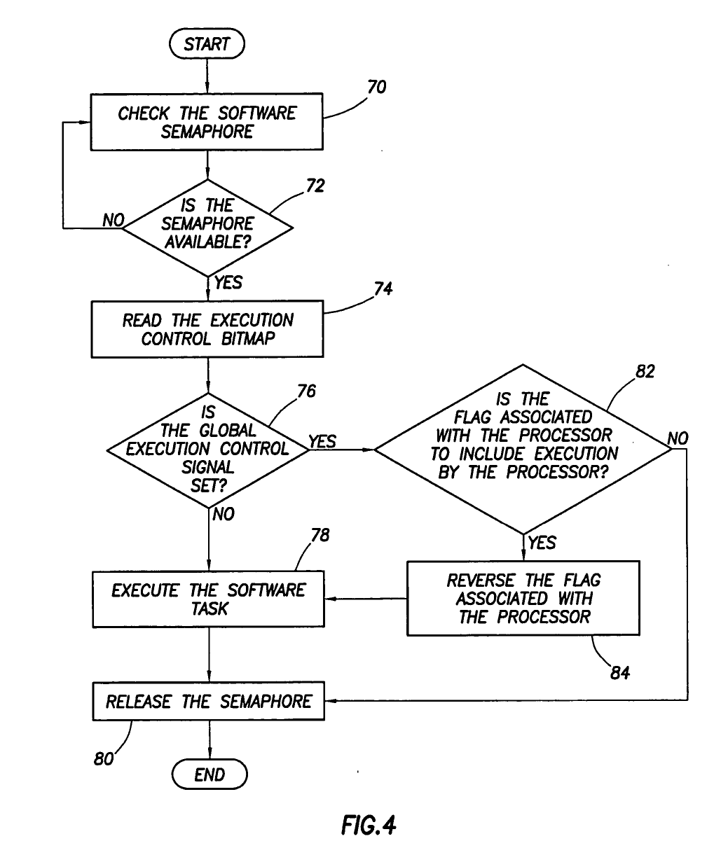

If it is determined at step 54 that the execution of the software task does require execution control, the global execution control signal 32 of bitmap flag 30 is set at step 56. At step 58 it is determined if the bootstrap processor has executed the software task. In some cases, the bootstrap processor will have previously executed the task as part of the initiation of the bootstrap processor. If the bootstrap processor has not previously executed the software task, the bit of the bitmap flag associated with the bootstrap processor, which in this example of bit 34 , is set to a logical 0 at step 68 to indicate that the bootstrap processor should be included in the remainder of the execution control method. The steps of FIG. 4 are performed with respect to the bootstrap processor and application processors without reference to the status of any processor as a bootstrap processor or an application processor. Following the setting of the bitmap flag for the bootstrap processor at step 68, the flow diagram continues at step 62.

If it is determined at step 54 that the bootstrap processor has previously executed the software task, bit 34 of the bitmap flag is set to a logical 1 at step 60 to exclude the bootstrap processor from subsequent execution of the software task. At step 62, the flags of the bitmap flag associated with each of the respective application processors are set to a logical 0 to include the application processors in the execution of the software task. Shown in FIG. 2A is an example of a bitmap flag 30 through step 62 of the method described in FIG. 3. In this example, the bootstrap processor has previously executed the software task. As a result, bit 34 of the bitmap flag is set to a logical 1 to exclude the bootstrap processor, including any logical processors of the bootstrap processors, from attempt to execute the software task. Bits 36-40 of the bitmap flag are set to a logical 0 to include these application processors in the execution of the software task. Following the step of setting the bitmap flag for the application processors at step 62, the software task is issued to the processors at step 64.

Shown in FIG. 4 is a flow diagram of a series of method steps for managing processor execution at each of the processors of the computer system. The steps of FIG. 4 begin following issuance of the software task to the processors at step 64 of FIG. 3 and are followed by each of the processors of the computer system. At step 70, each processor checks a semaphore associated with the software task to determine if the processor may execute the software task. The semaphore is a data structure flag that is used to indicate whether a shared resource is available or already in use. In one example, the semaphore may be stored in a register associated with the L3 cache to identify when the L3 cache is busy and when the L3 cache is available for execution of a software program to initiate the L3 cache with respect to the processor. If it is determined at step 72 that the semaphore is not available, the processor continues to attempt to gain control of the semaphore by repeating steps 70 and 72. Once the processor gains control of the semaphore, the processor reads the execution control bitmap 30. As described, bitmap 30 may be saved to a nonvolatile memory location accessible to each of the processors, including an external register accessible to each processor, such as a register of the north bridge of the computer system, or in other I/O locations.

The processor determines at step 76 if the global execution control signal at bit 32 of bitmap 30 is set. If the global execution control signal is not set, execution control is not enabled and the processor is free to execute the software task at 78 and release the semaphore at step 80. If the global execution control signal is set, it is determined at step 82 if the bit of the bitmap associated with the processor is set to include the processor in the execution of the software task. If the bit of the bit map is set to include the processor in the execution of the software task, the bit is reset at step 84 and the software task is executed by the processor, as indicated at step 78. The execution of the software task can be accomplished by one of the logical processors of the processors. The resetting of the bit of the bitmap at step 82 prevents multiple logical processors of a single from processors from repeatedly executing the software task. Thus, the method set out in FIG. 4 insures that the software task will be executed by only one of the logical processors of the computer system. Following the execution of the software task, the semaphore is released at step 80. The steps of FIG. 4 could likewise be executed with respect to individual logical processors of the computer system. In this embodiment, the flag associated with each logical processor would be examined in step 82. If a flag associated with a logical processor is set to include execution by the processor, the flag associated with the logical processor is reversed at step 84 and the software task is executed at the logical processor at step 78.

The bits of bitmap flag 30 or extended bitmap flag 42 could be set in a manner to control the order in which the processors of the logical processors of a computer system execute a certain software task. As an example, in the case of the bitmap flag 30 of FIG. 2A, if it were desired to execute the software task by the processors in the order of processor 12a, processor 12b, processor 12c, and processor 12d, bitmap flag would be initially set to 10111xxxx, indicating that only the processor 12a would execute the software task. The bootstrap processor would reset bitmap flag to 11011xxx and reinitiate the execution of the software task, resulting in the software task being executed by processor 12b. Bitmap flag could next be reset to 11101xxx, followed by a setting to 11110xxx, to cause the software task to be executed serially processor 12c and processor 12d. As such, the setting of the bits of the bitmap flag can be used to control the order with which the software task is executed by the processors or logical processors, in the case of the use of bitmap 42, of the computer system.

The method disclosed herein is sufficiently flexible that method can be to identify some processors for execution, while identifying other processors as not being eligible for prosecution. The flags of bitmap 30 can be set so that only a subset of the processors of the computer system execute the software task. In this manner, the technique disclosed herein may be used to selectively control the execution of certain software tasks by the processor of the computer system at startup of the computer system. Although the present disclosure has been described with respect to an information handling system, it should be recognized that the system and method disclosed herein has equal applicability to any information handling system that includes multiple processors. Although the present disclosure has been described in detail, it should be understood that various changes, substitutions, and alterations can be made hereto without departing from the spirit and the scope of the invention as defined by the appended claims.

What is claimed is:

1. A method for managing execution of software code by the processors of a multiprocessor computer system, comprising:
setting a first flag to identify whether the computer system is in a managed execution mode for the execution of the software code;
identifying at each processor whether the computer system is in a managed execution mode;
if the processor is in a managed execution mode, identifying at each processor whether a second, processor-specific flag has been set to limit execution of the software code by the processor;
executing the software code by the processor if the processor-specific flag indicates that the software code has not been previously executed by the processor.

2. The method for managing execution of software code by the processors of a multiprocessor computer system of claim 1, wherein the step of executing the software code by the processor, comprises the steps of:
determining if a semaphore is available to the processor;
acquiring the semaphore if the semaphore is available to the processor; and
executing the software code by the processor if the processor-specific flag indicates that the software code has not been previously executed by the processor.

3. The method for managing execution of software code by the processors of a multiprocessor computer system of claim 1, wherein the first flag and each processor specific flag comprise a bitmapped set of bits that are stored in a non-volatile memory location accessible to each of the processor of the computer system.

4. The method for managing execution of software code by the processors of a multiprocessor computer system of claim 1, wherein the first flag and each processor specific flag comprise a bitmapped set of bits that are stored in a non-volatile memory location in a bridge device of the computer system.

5. The method for managing execution of software code by the processors of a multiprocessor computer system of claim 1, wherein the step of identifying at each processor whether the computer system is in a managed execution mode comprises the step of identifying whether the first flag is set to identify that the computer system is in a managed execution mode.

6. The method for managing execution of software code by the processors of a multiprocessor computer system of claim 1, wherein one of the processors of the computer system is the bootstrap processor of the computer system.

7. The method for managing execution of software code by the processors of a multiprocessor computer system of claim 1, wherein one of the processor of the computer system is a bootstrap processor and wherein the bootstrap processor sets the first flag and each processor-specific second flag.

8. A information handling system, comprising
a bootstrap processor;
an application processor, wherein the bootstrap processor is communicatively coupled to the bootstrap processor via a bus;
wherein the bootstrap processor is operable to set a first flag to indicate whether the bootstrap processor and the application processor will execute a piece of software in a managed execution mode;
wherein the bootstrap processor and the application processor are operable to consult the first flag to determine if each will execute the piece of software in a managed execution mode;
wherein each of the bootstrap processor and the application processor are operable to execute the software code if the (a) first flag identifies that the processor will execute the software in a managed execution mode; and (b) a second flag indicates that the piece of software has not been executed by the processor.

9. The information handling system of claim 8,
wherein each of the bootstrap processor and the application processor include multiple logical processors; and
wherein each logical processor is operable to execute the piece of software.

10. The information handling system of claim 8,
wherein each of the bootstrap processor and the application processor include multiple logical processors;
wherein each logical processor is operable to execute the piece of software; and
wherein each logical processor is operable to reset the second flag to indicate that the piece of software has been executed by the processor and to prevent subsequent execution by other logical processors of the processor.

11. The information handling system of claim 8, wherein the first flag and the second flag associated with each of the bootstrap processor and the application processor comprise a bit set that is saved to nonvolatile memory within the information handling system.

12. The information handling system of claim 8, wherein the first flag and the second flag associated with each of the bootstrap processor and the application processor comprise a bit set that is saved to a nonvolatile memory within a bridge device that is coupled to the host bus of the computer system.

13. The information handling system of claim 8,
wherein each of the bootstrap processor and the application processor include multiple logical processors;
wherein each logical processor is operable to execute the piece of software;
wherein each logical processor is operable to reset the second flag to indicate that the piece of software has been executed by the processor and to prevent subsequent execution by other logical processors of the processor; and
wherein the first flag and the second flag associated with each of the bootstrap processor and the application processor comprise a bit set that is saved to a nonvolatile memory within a bridge device that is coupled to the host bus of the computer system.

14. The information handling system of claim 8, wherein each of the bootstrap processor and the application processor is unable to execute the piece of software unless the bootstrap processor or the application processor controls a semaphore accessible to each of the bootstrap processor and the application processor.

15. The information handling system of claim 8,
wherein each of the bootstrap processor and the application processor is unable to execute the piece of software unless the bootstrap processor or the application processor controls a semaphore accessible to each of the bootstrap processor and the application processor;
wherein each of the bootstrap processor and the application processor include multiple logical processors;
wherein each logical processor is operable to execute the piece of software;
wherein each logical processor is operable to reset the second flag to indicate that the piece of software has been executed by the processor and to prevent subsequent execution by other logical processors of the processor; and
wherein the first flag and the second flag associated with each of the bootstrap processor and the application processor comprise a bit set that is saved to nonvolatile memory within the information handling system.

16. A method for managing the execution of a software program in a multiprocessor computer system, comprising the steps of:
setting a execution control signal, wherein the execution control signal is set by a bootstrap processor of the computer system and identifies if the processors of the computer system will execute the software program in a controlled execution mode;
setting an execution enable signal for each logical processor of the computer system;
executing the software at each of the logical processors, wherein any logical processor will only execute the software program if (a) the execution control signal is set to indicate that the logical processor will execute the software programmed in a controlled execution mode, and (b) the execution enable signal associated with the logical processor indicates that the software program has not been executed with respect to the processor.

17. The method for managing the execution of a software program in a multiprocessor computer system of claim 16, wherein the step of resetting the execution enable signal associated with a logical processor following the execution of the software program.

18. The method for managing the execution of a software program in a multiprocessor computer system of claim 16, wherein the software program is executed in at least one of the processors by at least one of the logical processors of the processor.

19. The method for managing the execution of a software program in a multiprocessor computer system of claim 16, wherein the execution control signal and the execution enable signal for each logical processor are stored in a non-volatile memory location accessible by each of the processors of the computer system.

20. The method for managing the execution of a software program in a multiprocessor computer system of claim 16, wherein the execution control signal and the execution enable signal for each logical processor are stored in a non-volatile memory in a bridge device of the computer system.
